(19) United States
(12) Patent Application Publication
(10) Pub. No.: US 2014/0379835 A1
(43) Pub. Date: Dec. 25, 2014

(54) PREDICTIVE PRE-CACHING OF CONTENT

(71) Applicants: JEFFREY R. FOERSTER, Portland, OR (US); DANIEL J. DAHLE, Wilsonville, OR (US); MEIYUAN ZHAO, Santa Clara, CA (US)

(72) Inventors: JEFFREY R. FOERSTER, Portland, OR (US); DANIEL J. DAHLE, Wilsonville, OR (US); MEIYUAN ZHAO, Santa Clara, CA (US)

(21) Appl. No.: 13/923,870

(22) Filed: Jun. 21, 2013

(51) Int. Cl. H04L 29/08

(52) U.S. Cl. CPC H04L 67/2847
USPC 709/213

(57) ABSTRACT

Certain embodiments herein are directed to predictive pre-caching of content for user devices. A service provider system may receive predictive pre-cache information associated with a user from a user device. The service provider system may obtain content based at least in part on the predictive pre-cache information associated with the user. The service provider system may determine a non-congested time to transmit the obtained content. The service provider system may transmit the content to the user device at the non-congested time.

### TECHNICAL FIELD

Embodiments of this disclosure relate generally to wireless networks, and more particularly, to predictive pre-caching of content over wireless networks.

### BACKGROUND

With the dramatic rise in the use of mobile devices in recent years, users are able to access content from virtually any place. This enables users to simultaneously run errands while still being connected to different content. If a critical mass of people attempt to access content at similar times, the network traffic may negatively impact those attempting to access that content. For example, it may be surmised that people often have a daily routine. For instance, a person may wake up, have breakfast, and get ready for work. They may then commute to work. During the commute, the person may wish to access content. As it is common for people to often have similar routines, especially during the work week, the network traffic may be congested during similar times for those people. If all the people commuting to work are trying to access content from similar providers through the same service providers, then it is possible that those trying to access the content will be negatively impacted by the congestion of the network at that time.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example predictive pre-caching system in accordance with one or more embodiments of the disclosure.

FIG. 2 illustrates a block diagram of an example computing system for implementing a predictive pre-caching system in accordance with one or more embodiments of the disclosure.

FIG. 3 illustrative data flow between various components of an illustrative system architecture for software development kit latency monitoring in accordance with one or more embodiments of the disclosure.

FIG. 4 illustrates a flow diagram of an example process for predictive pre-caching of content, in accordance with one or more embodiments of the disclosure.

FIG. 5 illustrates a flow diagram of an example process for predictive pre-caching of content, in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Certain embodiments herein are directed to, among other things, the predictive pre-caching of content for user devices. As user devices, such as mobile devices, become increasingly prevalent, wireless spectrum becomes an increasingly scarce resource that should be utilized efficiently in order to maximize the capacity of the network and satisfy the needs of the user. The behavior of a user may be highly predictable. For example, the behavior of a user may be predicted based on their user preferences and historic usage patterns. Data usage patterns and location patterns may be generated based at least in part by data received from different modules from the user device, such as GPS information or data consumption information. Predictable user behavior may enable the system and methods described herein to leverage information associated with the users to maximize the utilization and/or efficiency of the network, by scheduling and storing content for mobile users in advance of the user seeking to access the content. For example, people may regularly check a social network for updates on their mobile phones during breaks or on lunch hours. Pre-caching the data associated with the user from the social media network during less busy times may make more efficient use of the wireless spectrum and may free up the capacity of the wireless spectrum when it might be needed most.

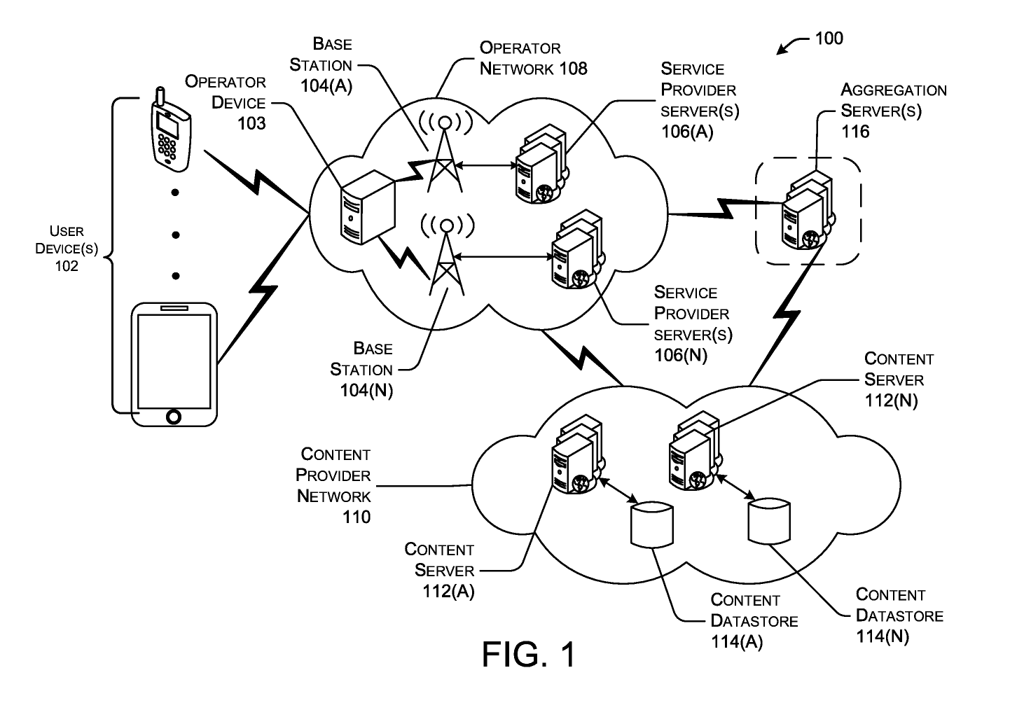

FIG. 1 depicts an example wireless communication system 100 that may be used to implement predictive pre-caching of content, according to an embodiment of the disclosure. As shown in FIG. 1, one or more user device(s) 102 may communicate with an operator network 108. An operator network 108 may include one or more base stations 104(A)-104(N) (collectively referred to as 104) in communication with one or more service provider server(s) 106(A)-106(N) (collectively referred to as 106). The operator network 108 may be in communication with a content provider network 110. The content provider network 110 may include one or more content servers 112(A)-112(N) (collectively referred to as 112), each of which may be in communication with one or more content datastores 114(A)-114(N) (collectively referred to as 114). In some embodiments, one or more aggregation servers 116 may be positioned between the operator network 108 and the content provider network 110. The aggregation servers may 116 reside within the operator network 108, the content provider network 110, or hosted by a third-party.

Although a certain number of each system, device, or network is shown in FIG. 1, a different number of each may exist in other examples. For example, numerous operator networks 108 that provide wireless services for the mobile device(s) 102 may participate in predictive pre-caching of content. Each of the systems or devices will now be described in turn.

The user device(s) 102 may include any suitable processor-driven computing device including, but not limited to, a smartphone or other cellular device, a tablet device, an electronic reader device, a desktop computing device, a laptop computing device, a mainframe computing device, a gaming console, a multimedia content streaming device, or any other device capable of accessing, receiving, and/or displaying content received over one or more of the networks. The user device(s) 102 may communicate with an operator network 108 and/or a content provider network 110.

The user devices 102(A)-102(N) may include hardware and/or software modules that may enable the user devices 102(A)-102(N) to communicate with a respective base stations 104(A) and 104(N) for sending information to the operator network 108. In one embodiment, the user devices 102(A)-102(N) may include software drivers that enable such communication.

Some configurations of the operator network may include a cloud computing arrangement in which shared computing resources, such as those described above, may perform one or more services associated with implementing the processes described herein. Other configurations may exist in other embodiments, including those in which functions described herein may be distributed among multiple systems or devices, or may be performed by a dedicated device.

The operator network 108 may include various systems, devices, or components that may configure the operator network 108 to enable wireless communication via the wireless spectrum. An operator network 108 may be owned, controlled, or managed by various service providers, such as wireless service providers, telecommunications service providers, or other providers that may be licensed to utilize one or more frequencies associated with the wireless spectrum. In certain embodiments herein, the service providers may provide cellular communication services to users of mobile devices, mobile telephones, or other devices that may include a radio.

According to one configuration, example devices in the operator network 108 may include, but are not limited to, an operator device 103 (or a mobile switching center), one or more base station(s) 104, one or more service provider server(s) 106. Fewer or more of the devices shown in the operator network 108 may exist in other embodiments. The operator device 103 may serve as a controller for the operator network 108, in one embodiment. For example, the operator device 103 may coordinate the actions of the base stations 104(A)-104(N), for example, as user devices 102(A)-102(N) move between cells covered by the base stations 104(A)-104(N). In another example, the operator device 103 may also serve as a switch for routing cellular communications into, or receiving communications from, the Public Switched Telecommunications Network (PSTN) or other networks. In a further example, the operator device 103 may also communicate with one or more visitor location registers (VLRs) and/or home location registers (HLRs) to access information associated with the user devices 102(A)-102(N), such as, but not limited to, a unique international mobile subscriber identity (IMSI), the services allowed for each IMSI, locations (e.g., last known location) of user devices 102(A)-102(N), and authentication data used to determine access to the operator network 108 for each user devices 102(A)-102(N).

Various communication links, including fiber optic links, cable links, microwave links configured to utilize wireless spectrum as described herein, etc., may connect the operator device 103 to PSTN devices (not shown), to the base stations 104, and to the one or more service provider servers 106, in one embodiment.

The base station(s) 104 may be a wireless communication station installed at a fixed location to facilitate communication over various types of networks, such as cellular Code Division Multiple Access (CDMA), Global System for Mobile Communications (GSM), wireless local loop, wide area network (WAN), wireless fidelity (WiFi), Worldwide Interoperability for Microwave Access (WiMax), etc. The base station(s) 104 may include a base transceiver station, a base station controller, and other components to facilitate such communication, in one configuration.

The base station controller may interface with the operator device 103 and may determine to which base stations 104 to route content, such as a voice call. The base station controller may route information to a particular base station 104(A) (for example, based on a geographic location of the base station 104(A) or 104(B)) in response to the operator network 108 determining the location of the user device 102.

The base station controller may also interface with base transceiver stations (or radio base stations), which may communicate directly with the user devices 102(A)-102(N). A base transceiver station may include various components, such as an electronics section and one or more antennas. The electronics section may include electronics for implementing communication with the user devices 102(A)-102(N). Such electronics may include radio frequency (RF) amplifiers, radio transceivers, RF combiners, and power supplies with redundant power sources, among other electronics. The one or more antennas may convert electric power into radio waves, and vice versa, for use by the base transceiver station. In some configurations, the base transceiver stations may be coupled to two sets of receive antennas to provide diversity reception, for example, to reduce the effects of multipath propagation.

The content provider network 110 may comprise one or more content server(s) 112(A)-112(N) each of which may be in communication with one or more content datastore 114(A) to 114(N). The content provider network 110 may receive requests from the operator network 108 for content for users. The content provider network 110 may receive user associated information, such as user profiles, authentication credential, or user preferences from the user devices 102 either directly or through the operator network 108. In some embodiments, a content server 112 may receive information from a service provider server 106 or a user device 102. The content server 112 may identify suggested content for a user device based at least in part on the received user preferences, authentication credentials, past viewing history, or the like. The content server may retrieve or otherwise obtain the content from one or more content datastores 114.

In some embodiments, the system 100 may include an optional aggregation server 116. The aggregation server 116 may be a server interposed between the data flow of the operator network 108 and the content provider network 110. The aggregation server may be used to pre-cache data from the content provider network 110 until required by the operator network 108 to transmit to one or more user devices 102.

At least a portion of the devices shown in FIG. 1 may include a radio receiver (not shown). A physical layer interface in the radio receiver may include a radio frequency (RF) unit that may be configured to provide for reception of one or more RF signals. According to one configuration, the RF unit may include an amplifier, a mixer, a local oscillator, and so forth. The RF unit may be implemented as discrete electronic components, integrated circuits, software-defined radio, or a combination thereof, according to various configurations. At least a portion of the devices in FIG. 1 may also include a radio transmitter that may enable the devices to send one or more RF signals to one another. In some configurations, the devices may include a radio transceiver that may receive and send RF signals. The transceiver (or the receiver and/or the transmitter) may be coupled to one or more antennas, such as those associated with the operator network 108.

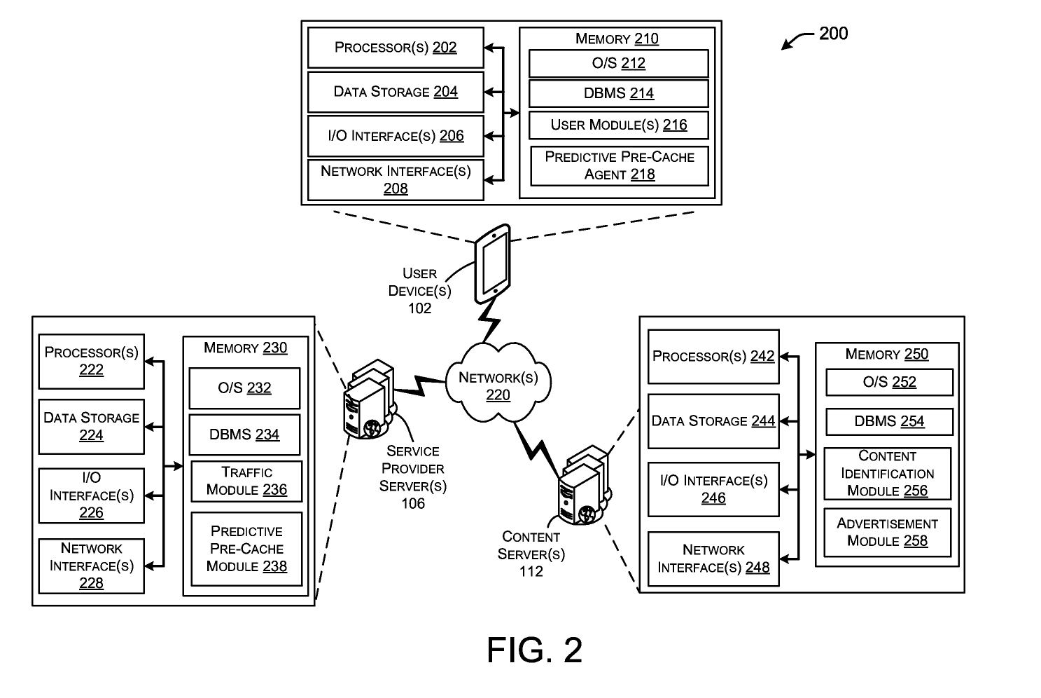

FIG. 2 is a more detailed schematic block diagram of various hardware and software components of the illustrative system architecture 100 depicted in FIG. 1 in accordance with one or more embodiments of the disclosure.

The illustrative architecture 200 may include one or more user devices 102 operable by one or more users, one or more service provider servers 106, one or more content servers 112, and, optionally, one or more aggregation server(s) 116. The user device(s) 102 may include, for example, the user device 102(A) operable by a user to interact with the service provider server(s) 106, the user device 102(N) operable by a user to interact with content server(s) 112, and so forth. The user device(s) 102 may include any suitable processor-driven computing device including, but not limited to, a smartphone or other cellular device, a tablet device, an electronic reader device, a desktop computing device, a laptop computing device, a mainframe computing device, a gaming console, a multimedia content streaming device, or any other device capable of accessing, receiving, and/or displaying content received over one or more of the networks 220.

The service provider server(s) 106, the content server(s) 112, and/or the aggregation server(s) 116 not limited to, a server computer configured to receive and respond to requests from client devices, a mainframe computer, or any other suitable computing device, and may be organized in accordance with any suitable configuration (e.g., a cluster of servers).

Any of the service provider server(s) 106, the content server(s) 112, and/or the aggregation server(s) 116 may be configured to communicate with any other such component of the architecture 200 via one or more networks 220. The network(s) 220 may include, but are not limited to, any one or a combination of different types of suitable communications networks such as, for example, cable networks, public networks (e.g., the Internet), private networks, wireless networks, cellular networks, or any other suitable private and/or public networks. Further, the network(s) 220 may have any suitable communication range associated therewith and may include, for example, global networks (e.g., the Internet), metropolitan area networks (MANs), wide area networks (WANs), local area networks (LANs), or personal area networks (PANs). In addition, the network(s) 220 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

Further, the service provider server(s) 106 may be further configured to communicate with various other components of the architecture 200 (e.g., the content server(s) 112), and/or the aggregation server(s) 116) via one or more networks 220 which may include, for example, one or more internal networks, secured networks, or the like associated with an entity that hosts the service provider server(s) 106, the content server(s) 112, and/or the aggregation server(s) 116. The network(s) 220 may include any one or more of the types of networks and communication mediums described above through reference to the network(s) 220.

In an illustrative configuration, the user device 102 may include one or more processor(s) 202, one or more memory devices 210 (generically referred to herein as memory 210), data storage 204, one or more input/output (“I/O”) interface(s) 206, and/or one or more network interface(s) 208. For ease of explanation, the user device 102 will be referred to hereinafter in the singular. However, it should be appreciated that multiple user devices 102 may be utilized.

The memory 210 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 210 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 210 may store computer-executable instructions that are loadable and executable by the processor(s) 202, as well as data manipulated and/or generated by the processor(s) 202 during the execution of the computer-executable instructions. For example, the memory 210 may store one or more operating systems (O/S) 212; one or more database management systems (DBMS) 214; one or more program modules such as one or more user module(s) 216, one or more predictive pre-cache agent(s) 218, and so forth; and/or various other types of data and/or computer-executable instructions. The various illustrative program modules depicted as being loaded into the memory 210 may include computer-executable instructions that responsive to execution by the processor(s) 202 cause various processing to be performed. In order to perform such processing, the program modules may utilize, at least in part, data stored in the memory 210, data stored in the data storage 204, and/or data stored in one or more external datastores (not shown).

The user module(s) 216 may include computer-executable instructions such as, for example, location tracking of the user device 102 (e.g., GPS tracking) or data usage associated with one or more user applications.

The predictive pre-cache agent 218 may obtain or receive data from one or more user module(s) 216 and generate predictive pre-cache information. For example, the predictive pre-cache agent 218 may obtain location tracking information from one or more user module(s) 216 and generate or update a location information pattern associated with the user device 102. In some embodiments, the predictive pre-cache agent 218 may generate one or more activity logs reflecting a user's interaction with the user device 102. In some embodiments, the predictive pre-cache agent 218 may generate or update data usage patterns based at least in part on data received or obtained from one or more user module(s) 216, such as location information received from a GPS device or data associated with the execution of one or more applications from the operating system. The predictive pre-cache agent 218 may transmit the predictive pre-cache information to a service provider server 106 and/or a content server 112. In some embodiments, the user device 102 may transmit the information to one or more base stations 104 that may then communicate the data to one or more service provider servers 106. In some embodiments, the user device 102 may transmit the information to one or more base stations 104 that may then communicate the data to one or more aggregation servers 116, if they are available in the system 200.

The (O/S) 212 loaded into the memory 210 may provide an interface between other application software executing on the user device 102 and hardware resources of the user device 102. More specifically, the O/S 212 may include a set of computer-executable instructions for managing hardware resources of the user device 102 and for providing common services to other application programs (e.g., managing memory allocation among various application programs). The O/S 212 may include any operating system now known or which may be developed in the future including, but not limited to, any server operating system, any desktop or laptop operating system, any mainframe operating system, any mobile operating system, or any other proprietary or freely available operating system.

The user device 102 may further include data storage 204 such as removable storage and/or non-removable storage including, but not limited to, magnetic storage, optical disk storage, and/or tape storage. Data storage 204 may provide non-transient storage of computer-executable instructions and other data. The data storage 204 may include storage that is internal and/or external to the user device 102. The memory 210 and/or the data storage 204, removable and/or non-removable, are examples of computer-readable storage media (CRSM) as that term is used herein.

It should be appreciated that any data and/or computer-executable instructions stored in the memory 210 may be additionally, or alternatively, stored in the data storage 204 and/or one or more external datastores (not shown). The DBMS 214 depicted as being loaded into the memory 210 may support functionality for accessing, retrieving, storing, and/or manipulating data stored in external datastore(s), data stored in the memory 210, and/or data stored in the data storage 204. The DBMS 214 may use any of a variety of database models (e.g., relational model, object model, etc.) and may support any of a variety of query languages.

The processor(s) 202 may be configured to access the memory 210 and execute computer-executable instructions stored therein. For example, the processor(s) 202 may be configured to execute computer-executable instructions of the various program modules of the user device 102 to cause or facilitate various operations to be performed in accordance with one or more embodiments of the disclosure. The processor(s) 202 may include any suitable processing unit capable of accepting digital data as input, processing the input data in accordance with stored computer-executable instructions, and generating output data. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The user device 102 may further include one or more I/O interfaces 206 that may facilitate the receipt of input information by the user device 102 from one or more I/O interfaces as well as the output of information from the user device 102 to the one or more I/O interfaces. The I/O interfaces 206 may include, for example, one or more user interface devices that facilitate interaction between a user and the user device 102 including, but not limited to, a display, a keypad, a pointing device, a control panel, a touch screen display, a remote control device, a microphone, a speaker, and so forth.

The user device 102 may be configured to communicate with any of a variety of other systems, platforms, devices, and so forth (e.g., the serviced provider server(s) 106, content servers 112, etc.) via one or more of the network(s) 220. The user device 102 may include one or more network interfaces 208 that may facilitate communication between the user device 102 and any of the above-mentioned systems, platforms or devices.

Referring now to the service provider server(s) 106, in an illustrative configuration, the service provider server(s) 106 may include one or more processor(s) 222, one or more memory devices 230 (generically referred to herein as memory 230), data storage 224, one or more input/output (“I/O”) interface(s) 226, and/or one or more network interface(s) 228. For ease of explanation, the service provider server(s) 106 will be referred to hereinafter in the singular. However, it should be appreciated that multiple service provider server(s) 106 may be provided.

The memory 230 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 230 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 230 may store computer-executable instructions that are loadable and executable by the processor(s) 222, as well as data manipulated and/or generated by the processor(s) 222 during the execution of the computer-executable instructions. For example, the memory 230 may store one or more operating systems (O/S) 232; one or more database management systems (DBMS) 234; one or more traffic module(s) 236; one or more predictive pre-cache module(s) 238; and/or various other types of data and/or computer-executable instructions. The various illustrative program modules depicted as being loaded into the memory 230 may include computer-executable instructions that in response to execution by the processor(s) 222 cause various processing to be performed. The data utilized by the various program modules may be stored in the memory 230 (as depicted), in the data storage 224, and/or in one or more external datastores (not shown).

The (O/S) 232 loaded into the memory 230 may provide an interface between other application software executing on the service provider server(s) 106 and hardware resources of the service provider server(s) 106. More specifically, the O/S 232 may include a set of computer-executable instructions for managing hardware resources of the service provider server(s) 106 and for providing common services to other application programs (e.g., managing memory allocation among various application programs). The O/S 232 may include any operating system now known or which may be developed in the future including, but not limited to, any server operating system, any desktop or laptop operating system, any mainframe operating system, any mobile operating system, or any other proprietary or freely available operating system.

The service provider server(s) 106 may further include data storage 224 such as removable storage and/or non-removable storage including, but not limited to, magnetic storage, optical disk storage, and/or tape storage. Data storage 224 may provide non-transient storage of computer-executable instructions and other data. The data storage 224 may include storage that is internal and/or external to the service provider server(s) 106. The memory 230 and/or the data storage 224, removable and/or non-removable, are examples of computer-readable storage media (CRSM) as that term is used herein.

It should be appreciated that any data and/or computer-executable instructions stored in the memory 230 may be additionally, or alternatively, stored in the data storage 224 and/or one or more external datastores (not shown). The DBMS 234 depicted as being loaded into the memory 230 may support functionality for accessing, retrieving, storing, and/or manipulating data stored in external datastore(s), data stored in the memory 230, and/or data stored in the data storage 224. The DBMS 234 may use any of a variety of database models (e.g., relational model, object model, etc.) and may support any of a variety of query languages.

The processor(s) 222 may be configured to access the memory 230 and execute computer-executable instructions stored therein. For example, the processor(s) 222 may be configured to execute computer-executable instructions of the various program modules of the service provider server(s) 106 to cause or facilitate various operations to be performed in accordance with one or more embodiments of the disclosure. The processor(s) 222 may include any suitable processing unit capable of accepting digital data as input, processing the input data in accordance with stored computer-executable instructions, and generating output data. The processor(s) 222 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The service provider server(s) 106 may further include one or more I/O interfaces 226 that may facilitate the receipt of input information by the service provider server(s) 106 from one or more I/O devices as well as the output of information from the service provider server(s) 106 to the one or more I/O devices. The I/O devices may include, for example, one or more user interface devices that facilitate interaction between a user and the ad campaign generation server including, but not limited to, a display, a keypad, a pointing device, a control panel, a touch screen display, a remote control device, a microphone, a speaker, and so forth.

The service provider server(s) 106 may be configured to communicate with any of a variety of other systems, platforms, devices, and so forth (e.g., the user device(s) 102, content servers 112, etc.) via one or more of the network(s) 220. The service provider server(s) 106 may include one or more network interfaces 228 that may facilitate communication between the service provider server(s) 106 and any of the above-mentioned systems, platforms or devices.

According to various embodiments of the disclosure, the traffic module 236 may include computer-executable instructions for facilitating receiving data from one or more user devices 102 and/or one or more base stations 104 to monitor network traffic and to identify times associated with high network congestion as well as identify time associated with low network congestion. In some embodiments, the traffic module 236 may estimate or predict network congestion based on historic data usage patterns and historic location information patterns obtained from one or more user devices 102.

Referring now to the content server(s) 112, in an illustrative configuration, the content server(s) 112 may include one or more processor(s) 242, one or more memory devices 250 (generically referred to herein as memory 250), data storage 244, one or more input/output (“I/O”) interface(s) 246, and/or one or more network interface(s) 248. For ease of explanation, the content server(s) 112 will be referred to hereinafter in the singular. However, it should be appreciated that multiple content server(s) 112 may be provided.

The memory 250 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 250 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 250 may store computer-executable instructions that are loadable and executable by the processor(s) 242, as well as data manipulated and/or generated by the processor(s) 242 during the execution of the computer-executable instructions. For example, the memory 250 may store one or more operating systems (O/S) 252; one or more database management systems (DBMS) 254; one or more content identification module(s) 256; one or more advertisement module(s) 258; and/or various other types of data and/or computer-executable instructions. The various illustrative program modules depicted as being loaded into the memory 250 may include computer-executable instructions that in response to execution by the processor(s) 242 cause various processing to be performed. The data utilized by the various program modules may be stored in the memory 250 (as depicted), in the data storage 244, and/or in one or more external datastores (not shown).

The (O/S) 252 loaded into the memory 250 may provide an interface between other application software executing on the content server(s) 112 and hardware resources of the content server(s) 112. More specifically, the O/S 252 may include a set of computer-executable instructions for managing hardware resources of the content server(s) 112 and for providing common services to other application programs (e.g., managing memory allocation among various application programs). The O/S 252 may include any operating system now known or which may be developed in the future including, but not limited to, any server operating system, any desktop or laptop operating system, any mainframe operating system, any mobile operating system, or any other proprietary or freely available operating system.

The content server(s) 112 may further include data storage 244 such as removable storage and/or non-removable storage including, but not limited to, magnetic storage, optical disk storage, and/or tape storage. Data storage 244 may provide non-transient storage of computer-executable instructions and other data. The data storage 244 may include storage that is internal and/or external to the content server(s) 112. The memory 250 and/or the data storage 244, removable and/or non-removable, are examples of computer-readable storage media (CRSM) as that term is used herein.

It should be appreciated that any data and/or computer-executable instructions stored in the memory 250 may be additionally, or alternatively, stored in the data storage 244 and/or one or more external datastores (not shown). The DBMS 254 depicted as being loaded into the memory 250 may support functionality for accessing, retrieving, storing, and/or manipulating data stored in external datastore(s), data stored in the memory 250, and/or data stored in the data storage 244. The DBMS 254 may use any of a variety of database models (e.g., relational model, object model, etc.) and may support any of a variety of query languages.

The processor(s) 242 may be configured to access the memory 250 and execute computer-executable instructions stored therein. For example, the processor(s) 242 may be configured to execute computer-executable instructions of the various program modules of the content server(s) 112 to cause or facilitate various operations to be performed in accordance with one or more embodiments of the disclosure. The processor(s) 242 may include any suitable processing unit capable of accepting digital data as input, processing the input data in accordance with stored computer-executable instructions, and generating output data. The processor(s) 242 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The content server(s) 112 may further include one or more I/O interfaces 246 that may facilitate the receipt of input information by the content server(s) 112 from one or more I/O devices as well as the output of information from the content server(s) 112 to the one or more I/O devices. The I/O devices may include, for example, one or more user interface devices that facilitate interaction between a user and the ad campaign generation server including, but not limited to, a display, a keypad, a pointing device, a control panel, a touch screen display, a remote control device, a microphone, a speaker, and so forth.

The content server(s) 112 may be configured to communicate with any of a variety of other systems, platforms, devices, and so forth (e.g., the user device(s) 102, service provider server(s) 106, etc.) via one or more of the network(s) 220. The content server(s) 112 may include one or more network interfaces 248 that may facilitate communication between the content server(s) 112 and any of the above-mentioned systems, platforms or devices.

According to various embodiments of the disclosure, the content identification module 256 may include computer-executable instructions for identification of content associated with a user. For example, the content identification module 256 may determine or identify content based at least in part on historic data associated with the user, a user profile, or other information associated with the user received from the user device 102. In some embodiments, the content identification module 256 may determine or identify content based at least in part by identifying content previously consumed by the user or other individual in a same class as the user based on preferences, user profile data, location, or the like.

According to various embodiment of the disclosure, the advertisement module 258 may include computer-executable instructions for identification of advertisements to be transmitted to the user device 102 for storage until presentation of predicted pre-cached content. For example, the advertisement module 258 may identify one or more advertisements based at least in part on a user profile, user preferences or other information associated with the user and received from the user device 102. In some embodiments, the content server 112 may communicate directly with the user device 102 to transmit advertisements to be stored locally until content is received for presentation. In some embodiments, the identified advertisements are transmitted with the content identified by the content identification module 256. The content and advertisements maybe pre-cached at an aggregation server 116 or may be transmitted to one or more service provider servers 106 for transmittal to one or more user devices 102.

Although not explicitly depicted in FIG. 2, it should be appreciated that aggregation server 116 may include hardware, software, and/or firmware components similar to those depicted and described in relation to the service provider server(s) 106, content server(s) 112, and/or additional or alternative components.

Those of ordinary skill in the art will appreciate that any of the components of the architecture 200 may include alternate and/or additional hardware, software or firmware components beyond those described or depicted without departing from the scope of the disclosure. More particularly, it should be appreciated that software, firmware or hardware components depicted or described as forming part of any of the illustrative components of the architecture 100, and the associated functionality that such components support, are merely illustrative and that some components may not be present or additional components may be provided in various embodiments. While various program modules have been depicted and described with respect to various illustrative components of the architecture 100, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, firmware and/or hardware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of ordinary skill in the art will appreciate that the illustrative networked architecture 200 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative architecture 200, or additional functionality.

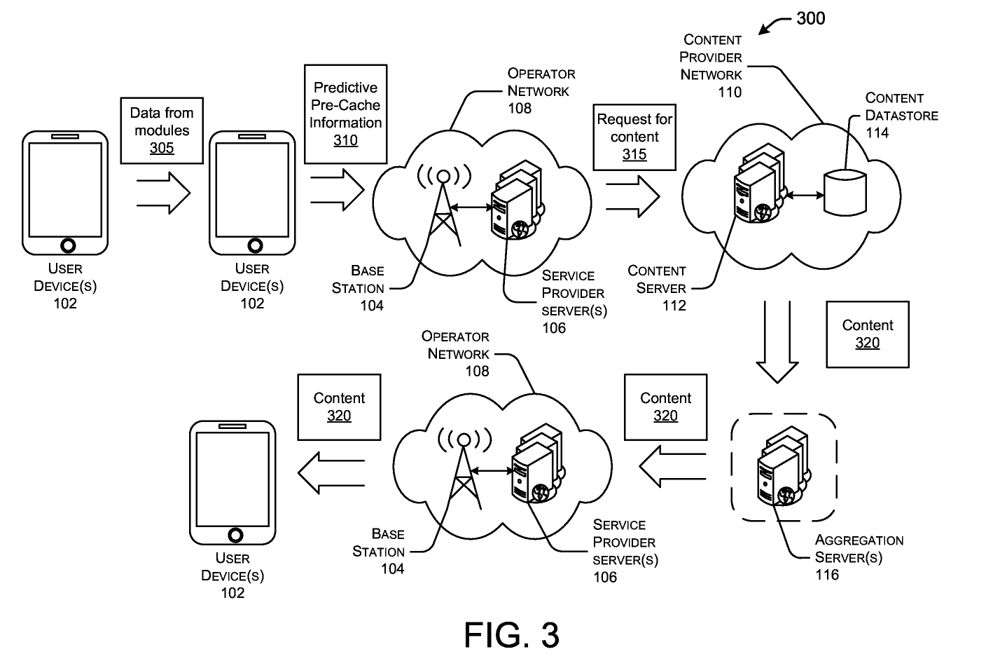

FIG. 3 illustrative data flow between various components of an illustrative system architecture for software development kit latency monitoring in accordance with one or more embodiments of the disclosure. One or more user modules 216 may obtain or generate data 305. For example, the user modules 216 may obtain or generate location tracking data of the user device 102 (e.g., GPS tracking) or data usage associated with one or more user applications. The one or more user modules 216 may transmit the data 305 to a predictive pre-cache agent 218 of the user device 102. The predictive pre-cache agent 218 may generate predictive pre-cache information 310. In some embodiments, the predictive pre-cache information 310 may include an activity log generated by the predictive pre-cache agent 218 based at least in part on data 305 received from one or more user modules 216. In some embodiments, the predictive pre-cache agent 218 may generate or update location information patterns based at least in part on the data 305 received from user modules 216 executing on the user device 102, such as information received from a GPS device or application. In some embodiments, the predictive pre-cache agent 218 may generate or update data usage patterns based at least in part on the data 305 received from user modules 216 executing on the user device 102.

The predictive pre-cache information 310 may be transmitted to the operator network 108. An operator device 103, base station 104, and/or service provider server 106 associated with the operator network 108 may receive or otherwise obtain the predictive pre-cache information 310 from a user device 102. The operator device 103, base station 104, and/or service provider server 106 may determine a time a network is not congested to transmit content 315 based at least in part the predictive pre-cache information 310. The service provider server 106 may generate and transmit a request 315 for content based at least in part on the determination. The service provider server 106 may transmit the request 315 to a content provider network 110. In some embodiments, the service provider server 106 may identify content 320 to be requested based at least in part on the predictive pre-cache information 310, user preferences, authentication credentials, or the like.

In some embodiments, the user device 102 may determine a time the network is not congested to obtain content 315. The user device 102 may transmit a request 315 to the operator network 108 for content. The operator network 108 may transmit the request 315 to the content provider network 110.

A content server 112 may receive the request 315 and may obtain the requested content from a content datastore 114. In some embodiments, the content server 112 may identify suggested content 320 for a user device 102 based at least in part on the received user preferences, authentication credentials, past viewing history, or the like.

In some embodiments, an aggregation server 116 may be optionally included in the system architecture. If present, the content server 112 may transmit the content 320 to the aggregation for storage until requested by the service provider server 106. If the aggregation server 116 is not available, the content server 112 may transmit the content 320 to a service provider server 106.

If the aggregation server 116 is included in the architecture, the service provider server 106 may obtain the pre-cached content 320 from the aggregation server 116 and transmit the content 320 to the user device 102 at the previously determined time when the network is not likely to be congested.

If the aggregation server 116 is not included in the architecture, the service provider server 106 may obtain the pre-cached content 320 from the content server 112 and transmit the content 320 to the user device 102 at the previously determined time when the network is not likely to be congested.

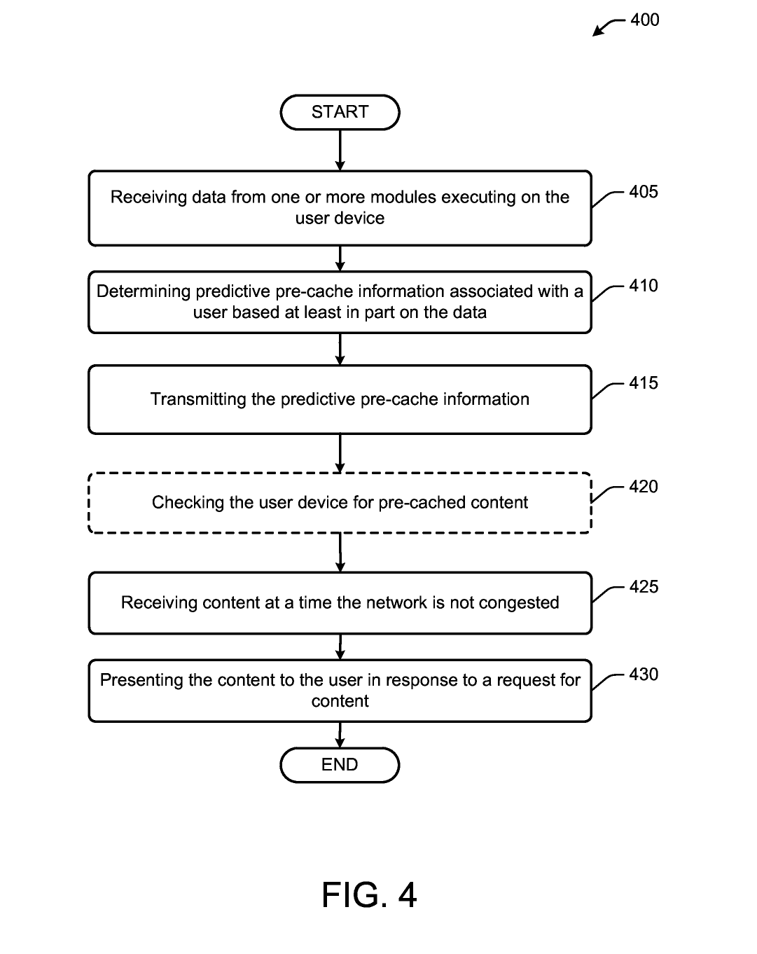

FIG. 4 illustrates a flow diagram of an example process for predictive pre-caching of content, in accordance with one or more embodiments of the disclosure. At block 405, the predictive pre-cache agent 218 of the user device 102 may receive data 305 from one or more modules 216 executing on the user device 102. The data 305 may include data from user modules 216 of the user device 102, such as location tracking information (e.g., GPS tracking, motion detectors, accelerometer, images, or the like), data consumption information for one or more user applications, and the like.

At block 410, the predictive pre-cache agent 218 of the user device 102 may determine predictive pre-cache information 310 associated with a user based at least in part on the data 305. Predictive pre-cache information 310 may include an activity log generated by the predictive pre-cache agent 218. In some embodiments, the predictive pre-cache agent 218 may generate or update location information patterns based at least in part on the data received from modules executing on the user device 102, such as information received from a GPS device or application. The predictive pre-cache agent 218 may retrieve previous location or data usage information to use in generating or updating the location information or data usage patterns. The predictive pre-cache agent 218 may store the data 305 received, such as data from a GPS device or application, as well as previously generated location information patterns.

In some embodiments, the predictive pre-cache agent 218 may generate or update data usage patterns based at least in part on the data received from modules 216 executing on the user device 102. For example, the predictive pre-cache agent 218 may receive or otherwise obtain information from the operating system of the user device with regards to data consumption for one or more applications executing on the user device 102. The data may include amount of data received, amount of data transmitted, rate at which data was received or transmitted, times associated with data transmissions, source of information, type of information, and the like. The predictive pre-cache agent 218 may retrieve previously stored data usage information associated with the user to use in generating or updating data usage patterns associated with the user. In some embodiments, the predictive pre-cache agent 218 may store data associated with data usage.

At block 415, the predictive pre-cache agent 218 transmit the predictive pre-cache data 310. In some embodiments, the predictive pre-cache agent 218 may transmit an activity log, location information patterns, data usage patterns, or any combination thereof. The predictive pre-cache agent 218 may transmit the predictive pre-cache data 310 to a content server 112 or a service provider server 106. In some embodiments, the predictive pre-cache agent 218 may transmit additional information to the different servers. For example, the predictive pre-cache agent 218 may transmit user preferences associated with content preferences or history of viewed content. In some embodiments, the predictive pre-cache agent 218 may transmit a user profile associated with a user to the content server 112. The predictive pre-cache agent 218 may transmit the predictive pre-cache data 310 and/or any additional data over one or more networks, such as any of the networks described herein.

Optionally, at block 420, the predictive pre-cache agent 218 may check the user device 102 for pre-cached content 320. For example, if the predictive pre-cache agent 218 has already received pre-cached content 320 from a remote server, such as an aggregation server 116, service provider server 106, or content server 112, the predictive pre-cache agent 218 may determine that additional content does not need to be downloaded from the remote server. The predictive pre-cache agent 218 may determine that minimal updates may be needed to the pre-cached content and obtain or receive additional content.

At block 425, the predictive pre-cache agent 218 may receive content 320 at a time the network 202 is not congested. In some embodiments, the user device 102 may receive content 320 at or near the time determined by a service provider server 106 that the network 202 will likely not be congested. In some embodiments, the user device 102 may receive content 320 from a service provider server 106, a content server 112, or an aggregation server 116. In some embodiments, the user device 102 may receive content 320 based at least in part on user preferences and/or data usage patterns prior to a request made by the user on the user device 102. In some embodiments, the user device 102 may receive updates to content already stored on the user device 102. For example, a user may typically check their social media network around 11:30 A.M. The user device 102 may receive predicted content around 10:30 AM. Based at least in part on a determination made by the service provider server 106 and/or content server 112, the user device 102 may receive additional updates to the content that was received around 10:30 AM, namely those updates that occurred subsequent to the last transmission of the content to the user device 102.

At block 430, the user device 102 may present the content 320 to the user in response to a request for content. In some embodiments, the user may request the content from a user device 102. The predictive pre-cache agent 114 may retrieve the content 320 stored on the user device 102 that was previously received from a service provider server 106, a content server 112, or an aggregation server 116 and stored on the user device 102 based at least in part on predictive pre-cache information associated with the user.

In some embodiments, the predictive pre-cache agent 218 may receive data 305 from one or more modules 216 executing on the user device 102. The predictive pre-cache agent 218 may determine predictive pre-cache information 310 associated with a user based at least in part on the data 305. The predictive pre-cache agent 218 may obtain or otherwise receive network congestion information. The network congestion information may be received from one or more service provider servers 106. The network congestion information may include historic data associated with network congestion. In some embodiments, the network congestion information may be information obtained from a plurality of user devices 102, aggregated, and anonymized. The network congestion information may be used to identify peak times of network utilization or efficiency. The network congestion information may be obtained from an operator device 103, a base station 104, or service provider server 106. The predictive pre-cache agent 218 may use the network congestion information to request, obtain, or receive content from a content server 112, aggregation server 116, or service provider server 106. In some embodiments, the predictive pre-cache agent 218 may obtain information associated with the network and obtain the content from a remote server, such as the content server 112, aggregation server 116, or service provider server 106 prior to receiving a request from a user for the content.

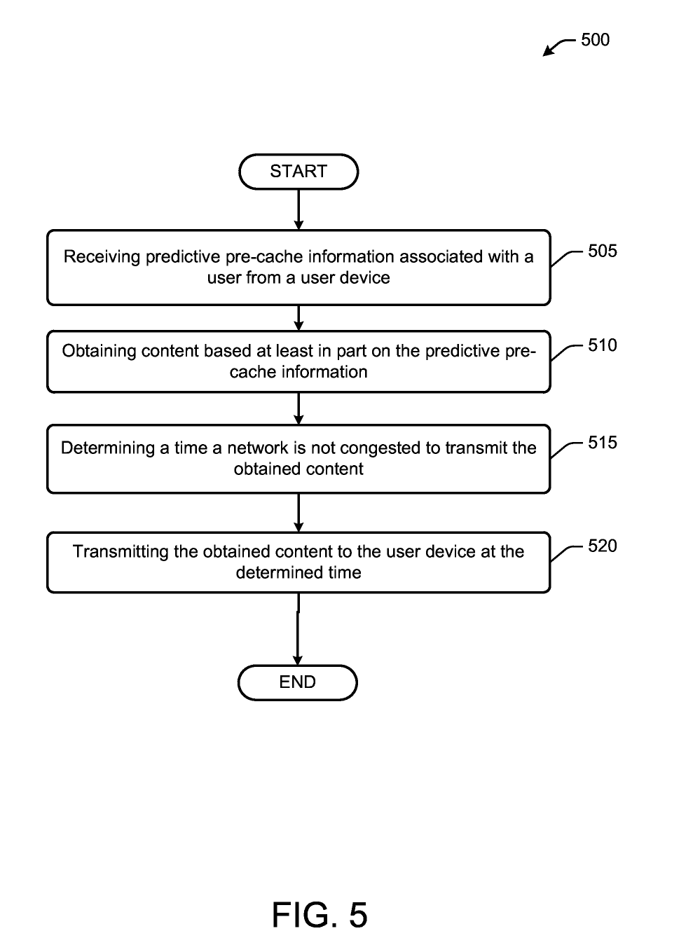

FIG. 5 illustrates a flow diagram of an example process for predictive pre-caching of content, in accordance with one or more embodiments of the disclosure. At block 505, a predictive pre-cache module 234 of a service provider server 106 may receive predictive pre-cache information 310 associated with a user from a user device 102. In some embodiments, the predictive pre-cache module 234 may receive the predictive pre-cache information 310 from a content server 112 that received it from the user device 102 or directly from the user device 102. In some embodiments, the predictive pre-cache information may include, but is not limited to, activity logs, location information patterns, data usage patterns, user preferences, and/or user profiles associated with the user.

At block 510, the predictive pre-cache module 234 may obtain content based at least in part on the predictive pre-cached information. In some embodiments, the predictive pre-cache module 234 may obtain the content from one or more content servers 112 or from an aggregation server 116. The aggregation server 116 may obtain content from the content server 112 based at least in part on authentication credentials shared with the content server 112 by the user device 102. In some embodiments, the authentication credentials may be shared with the aggregation server via one or more service provider servers 106. The aggregation server 116 may be located between the operator network 108 and the content provider network 110. The content may be identified by the content server 112 and pre-cached at the aggregation server 116 based at least in part on user preferences and/or a user profile associated with the user and shared by the user device 102 with the content server 112. The service provider server 106 may check the aggregation server 116 prior to requesting content from the content server 112.

At block 515, the predictive pre-cache module 234 may determine a time a network 202 is not congested to transmit or receive the obtained content. In some embodiments, the pre-cache module 234 may receive data from a plurality of user devices 102. The predictive pre-cache module 234 may aggregate and anonymize data received from the plurality of devices by removing personally identifying information from the received data. The predictive pre-cache module 234 may analyze the received data to identify times of peak and non-peak network traffic.

At block 520, the predictive pre-cache module 234 may transmit the obtained content to the user device 102 at the determined time. The predictive pre-cache module 234 may avoid transmitting data at peak network traffic times to reduce congestion and may proactively schedule transmission of data to a user device 102 prior to when the user is estimated to request the information.

In some embodiments, the predictive pre-cache information generated by the user device 102 may be considered private and locked on the mobile device 102 or at a network edge, such as a service provider server 106 for use authorized by the user so that the user may control the type of information, granularity and policy of when to share the predictive pre-cache information.

In some sharing the predictive pre-cache information by the user may enable the user to receive incentives and benefits, such as content not being counted towards a data-cap in a wireless plan, discount on video purchases, and the like.

In one embodiment, a method may be provided. The method may include receiving, by a service provider system comprising one or more computers, from a user device, predictive pre-cache information associated with a user. The method may further include obtaining, by the service provider system, content based at least in part on the predictive pre-cache information associated with the user. The method may include determining, by the service provider system, a time to transmit the obtained content based at least in part on network congestion information. The method may further include transmitting, by the service provider system, the obtained content to the user device at the determined time.

In one aspect of an embodiment, the predictive pre-cache information may comprise at least one of a user activity log, one or more location information patterns associated with the user, or one or more data usage patterns associated with the user.

In one aspect of an embodiment, obtaining the content may further comprise obtaining, by the service provider system, the content from a content server.

In one aspect of an embodiment, the method may further comprise receiving, by the service provider system from the content server, a plurality of advertisements identified by the content server based at least in part on one or more user preferences. The method may further comprise transmitting, by the service provider system, the plurality of advertisements for presentation to the user in association with the obtained content.

In one aspect of an embodiment, the plurality of advertisements may be transmitted to the user device for storage for presentation to the user in association with the obtained content prior to transmitting the obtained content.

In one aspect of an embodiment, the method may include identifying, by the service provider system, a credit to apply to a user account associated with the user device based at least in part on the presentation of the plurality of the advertisements to the user.

In one aspect of an embodiment, determining the time the network is not congested to transmit the obtained content may further comprise receiving, by the service provider system, data from a plurality of user devices. The method may include anonymizing, by the service provider system, the data received from the plurality of user devices. The method may further comprise analyzing, by the service provider system, the anonymized data to identify the time associated with peak and non-peak traffic associated with the network to predict the time the network is not congested.

In one aspect of an embodiment, the method may further include receiving, by the service provider server from a content server, suggested content based at least in part on one or more user preferences or a user profile shared by the user device with the content server. The method may include storing, by the service provider server, the suggested content on an aggregation server. The method may include retrieving, by the service provider server, the suggested content from the aggregation server responsive to receiving the predictive pre-cache data from the user device. The method may include transmitting, by the service provider server, the suggested content to the user device.

In another embodiment, a method may be provided. The method may include receiving, by a user device comprising one or more processors, data from one or more modules executing on the user device. The method may include determining, by the user device, predictive pre-cache information associated with a user based at least in part on the data. The method may include transmitting, by the user device, the predictive pre-cache data. The method may include receiving, by the user device, content at a time based at least in part on network congestion information and prior to the user device receiving a request for the content. The method may include presenting, by the user device, the content to a user response to a request for content.

In one aspect of an embodiment, the predictive pre-cache data may comprise at least one of location information patterns associated with the user device or data usage patterns associated with the user device.

In one aspect of an embodiment, the method may include generating, by the user device, an activity log based at least in part on interactions of a user with the user device. The method may further include transmitting, by the user device, the activity log to at least one of the service provider server or the content server.

In one aspect of an embodiment, transmitting the predictive pre-cache information may further comprise transmitting, by the user device, the predictive pre-cache information to at least one of a content server or a service provider server.

In another embodiment, a system may be provided. The system may include at least one memory that stores computer-executable instructions and at least one processor configured to access the at least one memory. The at least one processor may be configured to execute the computer-executable instructions to: receive from a user device, predictive pre-cache information associated with a user; obtain content based at least in part on the predictive pre-cache information associated with the user; determine a time a network is not congested to transmit the obtained content; and transmit the obtained content to the user device at the determined times.

In one aspect of an embodiment, the predictive pre-cache information may comprises at least one of a user activity log, one or more location information patterns associated with the user, or one or more data usage patterns associated with the user.

In one aspect of an embodiment, the at least one processor configured to obtain the content may be further configured to execute the computer-executable instructions to obtain the content from a content server.

In one aspect of an embodiment, the at least one processor may be further configured to execute the computer-executable instructions to receive, from the content server, a plurality of advertisements identified by the content server based at least in part on one or more user preferences; and transmit, the plurality of advertisements for presentation to the user in association with the obtained content.

In one aspect of an embodiment, the plurality of advertisements are transmitted to the user device for storage for presentation to the user in association with the obtained content prior to transmitting the obtained content.

In one aspect of an embodiment, the at least one processor may be further configured to execute the computer-executable instructions to identify a credit to apply to a user account associated with the user device based at least in part on the presentation of the plurality of the advertisements to the user.

In one aspect of an embodiment, the at least one processor configured to determine the time the network is not congested may be further configured to execute the computer-executable instructions to receive data from a plurality of user devices; anonymize the data received from the plurality of user devices; and analyze the anonymized data to identify the time associated with peak and non-peak traffic associated with the network to predict the time the network is not congested.

In one aspect of an embodiment, the at least one processor may be further configured to execute the computer-executable instructions to receive, from a content server, suggested content based at least in part on one or more user preferences or a user profile shared by the user device with the content server; store the suggested content on an aggregation server; retrieve the suggested content from the aggregation server responsive to receiving the predictive pre-cache data from the user device; and transmit the suggested content to the user device.

In another embodiment, a system may be provided. The system may include at least one memory that stores computer-executable instructions and at least one processor configured to access the at least one memory. The at least one processor may be configured to execute the computer-executable instructions to receive data from one or more modules executing on a user device; determine predictive pre-cache information associated with a user based at least in part on the data; receive network congestion information; determine a time to obtain content based at least in part on the network congestion information; receive content at the determined time; and present the content to a user response to a request for content.

In one aspect of an embodiment, the predictive pre-cache data may comprise at least one of location information patterns associated with the user device or data usage patterns associated with the user device.

In one aspect of an embodiment, the at least one processor may be further configured to execute the computer-executable instructions to generate an activity log based at least in part on interactions of a user with the user device.

In one aspect of an embodiment, the at least one processor configured to receive network congestion information may be further configured to execute the computer-executable instructions to receive network congestion information to a service provider server.

In one aspect of an embodiment, the at least one processor may be further configured to execute the computer-executable instructions to identify a credit to a user account associated with the user device based at least in part on the predictive pre-cache information associated with the user.

In another embodiment, an apparatus may be provided. The apparatus may include means for receiving from a user device, predictive pre-cache information associated with a user; means for obtaining content based at least in part on the predictive pre-cache information associated with the user; means for determining a time to transmit the obtained content based at least in part on network congestion information; and means for transmitting the obtained content to the user device at the determined time.

In one aspect of an embodiment, the predictive pre-cache information may comprise at least one of a user activity log, one or more location information patterns associated with the user, or one or more data usage patterns associated with the user.

In one aspect of an embodiment, the means for obtaining the content may further comprise means for obtaining the content from a content server.

In one aspect of an embodiment, the apparatus may include means for receiving, from the content server, a plurality of advertisements identified by the content server based at least in part on one or more user preferences; and means for transmitting the plurality of advertisements for presentation to the user in association with the obtained content.

In one aspect of an embodiment, the plurality of advertisements may be transmitted to the user device for storage for presentation to the user in association with the obtained content prior to transmitting the obtained content.

In one aspect of an embodiment, the apparatus may include means for identifying a credit to apply to a user account associated with the user device based at least in part on the presentation of the plurality of the advertisements to the user.

In one aspect of an embodiment, the means for determining the time the network is not congested to transmit the obtained content may further comprise means for receiving data from a plurality of user devices; means for anonymizing the data received from the plurality of user devices; and means for analyzing the anonymized data to identify the time associated with peak and non-peak traffic associated with the network to predict the time the network is not congested.

In one aspect of an embodiment, the apparatus may include means for receiving, from a content server, suggested content based at least in part on one or more user preferences or a user profile shared by the user device with the content server; means for storing the suggested content on an aggregation server; means for retrieving the suggested content from the aggregation server responsive to receiving the predictive pre-cache data from the user device; and means for transmitting the suggested content to the user device.

In another embodiment, an apparatus may be provided. The apparatus may include means for receiving data from one or more modules executing on the user device; means for determining predictive pre-cache information associated with a user based at least in part on the data; means for transmitting the predictive pre-cache data; means for receiving content at a time based at least in part on network congestion information and prior to the user device receiving a request for the content; and means for presenting the content to a user response to a request for content.

In one aspect of an embodiment, the predictive pre-cache data may comprise at least one of location information patterns associated with the user device or data usage patterns associated with the user device.

In one aspect of an embodiment, the apparatus may include means for generating an activity log based at least in part on interactions of a user with the user device; and means for transmitting the activity log to at least one of the service provider server or the content server.

In one aspect of an embodiment, the means for transmitting the predictive pre-cache information may further comprise means for transmitting the predictive pre-cache information to at least one of a content server or a service provider server.

In another embodiment, a non-transitory computer-readable medium comprising instructions may be provided. When the instructions are execute by at least one processor, the processor may receive data from one or more modules executing on the user device; determine predictive pre-cache information associated with a user based at least in part on the data; transmit the predictive pre-cache data; receive content at a time based at least in part on network congestion information and prior to the user device receiving a request for the content; and present the content to a user response to a request for content.

In one aspect of an embodiment, the predictive pre-cache data may comprise at least one of location information patterns associated with the user device or data usage patterns associated with the user device.

In one aspect of an embodiment, the instructions may further cause the at least one processor to generate an activity log based at least in part on interactions of a user with the user device; and transmit the activity log to at least one of the service provider server or the content server.

In one aspect of an embodiment, the instructions to transmit the predictive pre-cache may further cause the at least one processor to transmit the predictive pre-cache information to at least one of a content server or a service provider server.

In another embodiment, a method may be provided. The method may include receiving, by a user device comprising one or more processors, data from one or more modules executing on a user device; determining, by the user device, predictive pre-cache information associated with a user based at least in part on the data; receiving, by the user device, network congestion information; determining, by the user device, a time to obtain content based at least in part on the network congestion information; receiving, by the user device, content at the determined time; and presenting, by the user device, the content to a user response to a request for content.

In one aspect of an embodiment, the predictive pre-cache data may comprise at least one of location information patterns associated with the user device or data usage patterns associated with the user device.

In one aspect of an embodiment, the method may further include generating, by the user device, an activity log based at least in part on interactions of a user with the user device.

In one aspect of an embodiment, receiving network congestion information may further include receiving, by the user device, network congestion information to a service provider server.

In one aspect of an embodiment, the method may further include identifying, by the user device, a credit to a user account associated with the user device based at least in part on the predictive pre-cache information associated with the user.

In another embodiment, an apparatus may be provided. The apparatus may include means for receiving data from one or more modules executing on a user device; means for determining predictive pre-cache information associated with a user based at least in part on the data; means for receiving network congestion information; means for determining a time to obtain content based at least in part on the network congestion information; means for receiving content at the determined time; and means for presenting the content to a user response to a request for content.

In one aspect of an embodiment, the predictive pre-cache data may comprise at least one of location information patterns associated with the user device or data usage patterns associated with the user device.

In one aspect of an embodiment, the apparatus may include means for generating an activity log based at least in part on interactions of a user with the user device.

In one aspect of an embodiment, the means for receiving network congestion information may further comprise means for receiving network congestion information to a service provider server.

In one aspect of an embodiment, the apparatus may include means for identifying a credit to a user account associated with the user device based at least in part on the predictive pre-cache information associated with the user.

### CONCLUSION

The above descriptions and examples are for purposes of illustration and are not meant to be limiting. Additional descriptions and examples may exist in other embodiments. For example, at least a portion of the functionality described in association with certain devices may be performed by one or more other devices. In this way, the described functionality may be distributed among one or any number or combination of devices. As another example, different modules for implementing other types of functionality, types of communication, etc., in support of dynamically allocating wireless spectrum and utilizing the wireless spectrum in an operator network may also exist.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation. The patentable scope of certain embodiments of the present disclosure is defined in the claims, and may include other examples that occur to those skilled in the art.

What is claimed is:

1. A method, comprising:
receiving, by a service provider system comprising one or more computers, from a user device, predictive pre-cache information associated with a user;
obtaining, by the service provider system, content based at least in part on the predictive pre-cache information associated with the user;
determining, by the service provider system, a time to transmit the obtained content based at least in part on network congestion information; and
transmitting, by the service provider system, the obtained content to the user device at the determined time.

2. The method of claim 1, wherein the predictive pre-cache information comprises at least one of a user activity log, one or more location information patterns associated with the user, or one or more data usage patterns associated with the user.

3. The method of claim 1, wherein obtaining the content further comprises obtaining, by the service provider system, the content from a content server.

4. The method of claim 3, further comprising:
receiving, by the service provider system from the content server, a plurality of advertisements identified by the content server based at least in part on one or more user preferences; and
transmitting, by the service provider system, the plurality of advertisements for presentation to the user in association with the obtained content.

5. The method of claim 4, wherein the plurality of advertisements are transmitted to the user device for storage for presentation to the user in association with the obtained content prior to transmitting the obtained content.

6. The method of claim 5, further comprising:
identifying, by the service provider system, a credit to apply to a user account associated with the user device based at least in part on the presentation of the plurality of the advertisements to the user.

7. The method of claim 1, wherein determining the time to transmit the obtained content based at least in part on network congestion information further comprises:
receiving, by the service provider system, data from a plurality of user devices;
anonymizing, by the service provider system, the data received from the plurality of user devices; and
analyzing, by the service provider system, the anonymized data to identify the time associated with peak and non-peak traffic associated with the network to predict the time the network is not congested.

8. The method of claim 1, further comprising:
receiving, by the service provider system from a content server, suggested content based at least in part on one or more user preferences or a user profile shared by the user device with the content server;
storing, by the service provider system, the suggested content on an aggregation server;
retrieving, by the service provider system, the suggested content from the aggregation server responsive to receiving the predictive pre-cache data from the user device; and
transmitting, by the service provider system, the suggested content to the user device.

9. A method, comprising:
receiving, by a user device comprising one or more processors, data from one or more modules executing on the user device;
determining, by the user device, predictive pre-cache information associated with a user based at least in part on the data;
transmitting, by the user device, the predictive pre-cache data;
receiving, by the user device, content at a time based at least in part on network congestion information and prior to the user device receiving a request for the content; and
presenting, by the user device, the content to a user response to a request for content.

10. The method of claim 9, wherein the predictive pre-cache data comprises at least one of location information patterns associated with the user device or data usage patterns associated with the user device.

11. The method of claim 9, further comprising:
generating, by the user device, an activity log based at least in part on interactions of a user with the user device; and
transmitting, by the user device, the activity log to at least one of a service provider server or a content server.

12. The method of claim 9, wherein transmitting the predictive pre-cache information further comprises transmitting, by the user device, the predictive pre-cache information to at least one of a content server or a service provider server.

13. A system, comprising:
at least one memory that stores computer-executable instructions; and
at least one processor configured to access the at least one memory, wherein the at least one processor is configured to execute the computer-executable instructions to:
receive from a user device, predictive pre-cache information associated with a user;
obtain content based at least in part on the predictive pre-cache information associated with the user;
determine a time a network is not congested to transmit the obtained content; and
transmit the obtained content to the user device at the determined times.

14. The system of claim 13, wherein the predictive pre-cache information comprises at least one of a user activity log, one or more location information patterns associated with the user, or one or more data usage patterns associated with the user.

15. The system of claim 13, wherein the at least one processor configured to obtain the content is further configured to execute the computer-executable instructions to:
obtain the content from a content server.

16. The system of claim 15, wherein the at least one processor is further configured to execute the computer-executable instructions to:
receive, from the content server, a plurality of advertisements identified by the content server based at least in part on one or more user preferences; and
transmit the plurality of advertisements for presentation to the user in association with the obtained content.

17. The system of claim 16, wherein the plurality of advertisements are transmitted to the user device for storage for presentation to the user in association with the obtained content prior to transmitting the obtained content.

18. The system of claim 17, wherein the at least one processor is further configured to execute the computer-executable instructions to:
identify a credit to apply to a user account associated with the user device based at least in part on the presentation of the plurality of the advertisements to the user.

19. The system of claim 13, wherein the at least one processor configured to determine the time the network is not congested is further configured to execute the computer-executable instructions to:
receive data from a plurality of user devices;
anonymize the data received from the plurality of user devices; and
analyze the anonymized data to identify the time associated with peak and non-peak traffic associated with the network to predict the time the network is not congested.

20. The system of claim 13, wherein the at least one processor is further configured to execute the computer-executable instructions to:
receive, from a content server, suggested content based at least in part on one or more user preferences or a user profile shared by the user device with the content server;
store the suggested content on an aggregation server;
retrieve the suggested content from the aggregation server responsive to receiving the predictive pre-cache data from the user device; and
transmit the suggested content to the user device.

21. A system, comprising:
at least one memory that stores computer-executable instructions; and
at least one processor configured to access the at least one memory, wherein the at least one processor is configured to execute the computer-executable instructions to:
receive data from one or more modules executing on a user device;
determine predictive pre-cache information associated with a user based at least in part on the data;
receive network congestion information;
determine a time to obtain content based at least in part on the network congestion information;
receive the content at the determined time; and
present the content to a user response to a request for content.

22. The system of claim 21, wherein the predictive pre-cache data comprises at least one of location information patterns associated with the user device or data usage patterns associated with the user device.

23. The system of claim 21, wherein the at least one processor is further configured to execute the computer-executable instructions to:
generate an activity log based at least in part on interactions of a user with the user device.

24. The system of claim 21, wherein the at least one processor configured to receive network congestion information is further configured to execute the computer-executable instructions to:
receive network congestion information from a service provider server.

25. The system of claim 21, wherein the at least one processor is further configured to execute the computer-executable instructions to:
identify a credit to a user account associated with the user device based at least in part on the predictive pre-cache information associated with the user.
